(19) United States
(12) Patent Application Publication
(10) Pub. No.: US 2008/0135267 A1
(43) Pub. Date: Jun. 12, 2008

(54) Hand operated cultivating tool

(76) Inventor: Christopher Karczewski, Kansas City, MO (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/637,528

(22) Filed: Dec. 12, 2006

(51) Int. Cl. A01B 1/10

(52) U.S. Cl. 172/378

(57) ABSTRACT

A cultivating tool for use in flowerbeds and gardens is the subject of this invention. A unique blade configuration with a knife-like leading edge and a trailing edge having at least one flange section provides for ease in cultivating action with superior soil mixing. A mixing fork in the shape of a wishbone extends downwardly from the blade mounting plate to further enhance the cultivating action.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND OF THE INVENTION

This invention relates generally to hand cultivators and, more particularly, to a hand cultivator which can be used in a standing position.

Hand cultivators were one of the earliest tools used by man. They have taken various forms and shapes over the centuries and to some degree have been completely replaced by power equipment. There are, however, many applications where hand tools are preferred and a number of applications where hand tools can be employed when power tools cannot be. Examples of popular prior art hand cultivators are shown and described in the following U.S. Letters Patents: U.S. Pat. No. 256,039; U.S. Pat. No. 2,082,476; U.S. Pat. No. 2,855,668; U.S. Pat. No. 4,905,768; U.S. Pat. No. 6,843,324; and U.S. Design Pat. No. 406,219.

### BRIEF SUMMARY OF THE INVENTION

The present invention represents an improvement in hand cultivating tools by providing a unique design which combines ease in operating function together with improved mixing capabilities. These advantages are attributable to a blade design which incorporates a leading knife edge and a flanged trailing edge.

### BRIEF DESCRIPTION OF THE DRAWINGS

FIG. 1 a perspective view of the cultivating tool according to the present invention;

FIG. 2 is an enlarged, partially exploded view showing the working end of the tool;

FIG. 3 is a fragmentary bottom plane view of the working end of the tool; and

FIG. 4 is an enlarged, elevational view of the working end of the tool.

### DETAILED DESCRIPTION OF PREFERRED EMBODIMENT

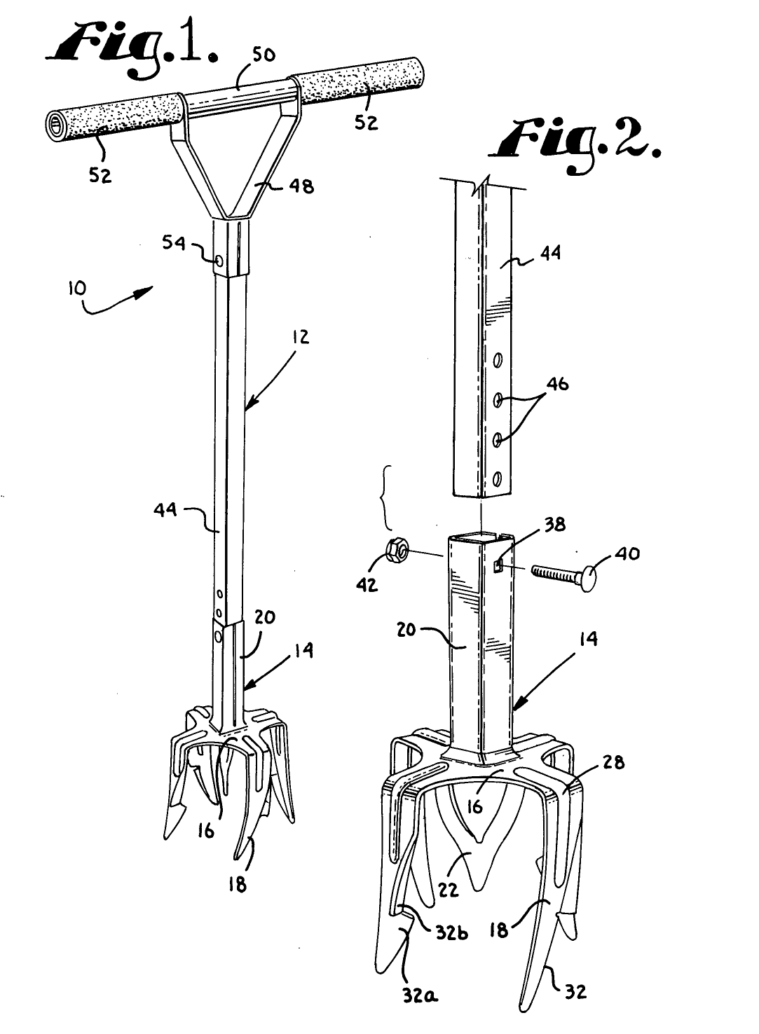

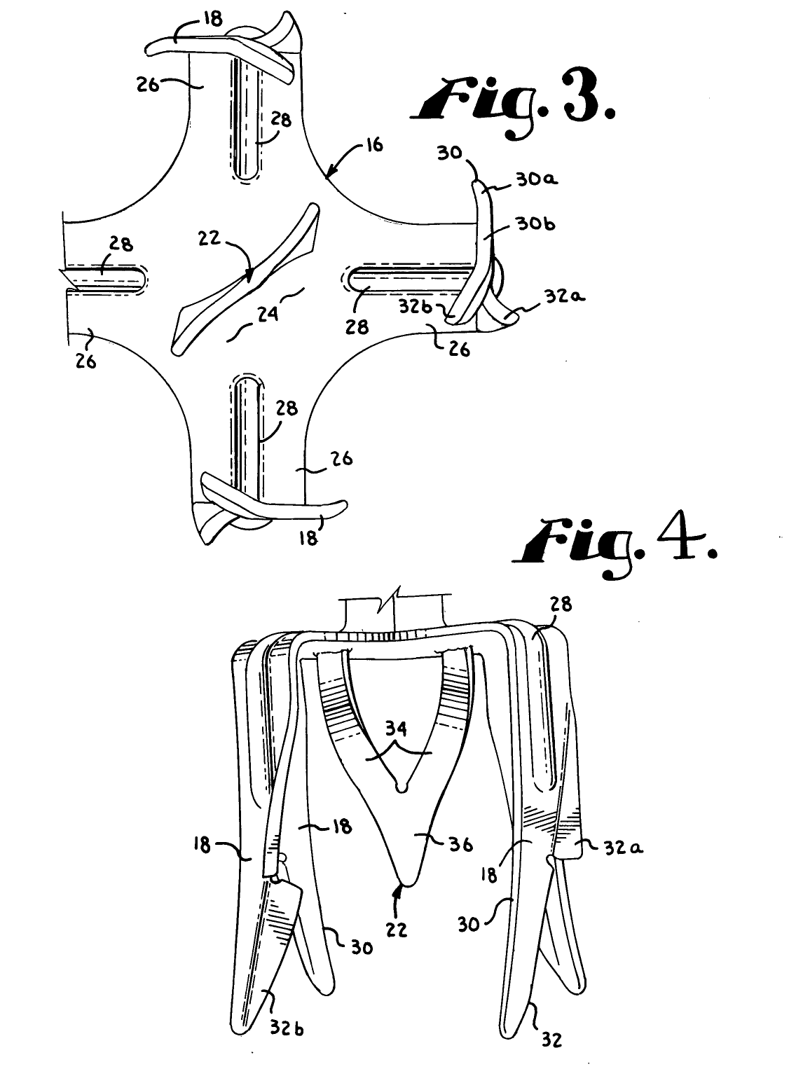

Referring initially to FIG. 1 the cultivating tool according to the present invention is designated generally by the numeral 10. Tool 10 includes a handle component 12 and a cultivating component 14. Cultivating component 14 includes a generally horizontal plate 16 and a plurality of blades 18 which extend generally perpendicular to and downwardly from plate 16. A handle-mounting stem 20 extends upwardly from plate 16. Referring to FIG. 3, horizontal plate 16 is generally cross-shaped with a center section 24 and four equispaced arms 26. It is to be understood that the left arm, when viewing FIG. 3, has been cut off, but in actual practice this arm would be identical to the other arms 26 shown in full. A reinforcing rib 28 is integrally formed in each arm 26 and extends substantially the length of the arm.

Referring additionally to FIG. 4, each of blades 18 is integral with plate 16 and depends from one of arms 26 at a 90 degree angle relative to the plate. In this regard, it is to be noted that reinforcing ribs 28 extend through approximately the upper ⅓ of each of blades 18. The under side of each reinforcing rib 28, which is visible in FIG. 3, is generally concave, while the upper surface of each of the ribs 28, which is visible in FIG. 4 is generally convex.

Still referring to FIG. 4, each of blades 18 is identical, and therefore only one will be described in detail. The blade 18 is of a generally v-shaped configuration with a leading edge 30 and a trailing edge 32. As best seen in FIG. 3, the leading edge 30 is tapered in a vertical plane to present a knife edge and facilitate cutting through soil. As best seen in FIG. 4, the leading edge 30 also extends along an imaginary curvilinear line, such that the tip of blade 32 lies at a point on an imaginary cylinder which encompasses the blades, at a point circumferentially spaced from the point where the blade joins horizontal plate 16. Finally, as visible in FIG. 3, that portion 30a of blade 18 which presents leading edge 30 extends at an acute angle relative to the central section 30b of the blade.

As best seen in FIG. 2, trailing edge 32 of blade 18 also follows a generally curvilinear line. Trailing edge 32 is presented by first and second flange sections 32a and 32b. Flange section 32a extends from the central section 30b at a first acute angle and second flange section 32b extends from the central blade section 30b at an acute angle in the opposite direction. It is to be noted that each flange section is of approximately equal length and each extends over approximately 30%-40% of the total length of the blade 18.

Still referring to FIGS. 3 and 4, details of mixing fork 22 will now be described. Mixing fork 22 is generally wishbone-shaped with two legs 34 which merge together to present a mixing tip 36. As readily ascertained from viewing FIG. 3, mixing fork 22 is formed in a twisted non-linear shape. The tip of mixing fork 32 is vertically spaced above the tips of blades 18 resulting in an overall length of the mixing fork which is approximately 50-60% of the length of blades 18.

Referring now to FIGS. 1 and 2, handle mounting stem 20 is rigid with horizontal plate 16 and is of generally rectangular configuration with an open top. An opening 38 receives a bolt 40. A nut 42 secures the bolt in the opening. As visible in FIG. 1, one side of the box presented by stem 20 has a longitudinal slit for purposes to be made clear hereinafter.

Handle component 12 includes an elongated, rectangular, upright handle support 44 which has a plurality of openings 46 vertically spaced near the bottom. Upright support 44 is of a configuration so that it can be telescopically received by handle mounting stem 20. The opposite end of support 44 receives a Y-shaped bracket 48 which supports a handle 50 having hand grips 52. Bracket 48 is telescopically received by support 44 and secured thereto by a rivet 54.

The working height of the tool is adjusted by placing bolt 40 in an appropriate opening 38 and then securing nut 42. The aforementioned slit in stem 20 allows the stem to tightly grip handle support 44. The tool is activated by placing it on the ground with the operator holding handle grips 52 with both hands. The tool is then rotated to initiate the cultivating action although it is not necessary to rotate it a complete 360 degrees. An effective cultivating action can be achieved with 90-180 degrees of rotation and with the operator first moving the tool in a clockwise direction followed by the reverse counter-clockwise movement. This action is repeated until the desired degree of cultivation is accomplished. The tool may be used to cultivate any type of soil but is particularly useful where there is no sod present to impede the initial penetration and cultivating action. The pointed tips of blades 18 easily penetrate the soil and the tapered knife edge of the blades presented by the leading edge 30 facilitate slicing through the soil. The cultivating action is further promoted by flanges 32a and 32b on the trailing edge of the blades. The curvilinear shape of the blades further facilitates movement through the soil since the operator will not encounter the soil resistance to rotational movement which would be the case if the blades were straight.

The position of mixing fork 22, the tip of which is vertically spaced from the tip of the blades, promotes mixing of the soil while providing only limited additional resistance to rotational movement of the tool by virtue of the fact that the soil has already been loosened by the blades as a result of their longer length and greater depth penetration before the soil encounters the tip of the mixing fork. The fact that mixing fork 22 is of a twisted non-planar configuration promotes both the mixing action and reduces the resistance to rotation movement when the mixing fork is in contact with the soil.

It will be appreciated that openings 46 and bolt 40 accommodate adjustment of handle component 12 so as to provide the desired working height for different individuals who may be using the tool.

It will be appreciated that while the rectangular configuration of handle component 12 is preferable because of the strength attributable to this configuration, other handle configurations, particularly, a round upright support is within the scope of the present invention. This would require that mounting stem 20 and Y-bracket 48 also be of a round configuration.

It is also contemplated that bracket 48 may be removably secured to support 44 or permanently affixed thereto.

It is also within the scope of this invention to have handle component 12 be directly secured to horizontal plate 12 either through utilization of mounting stem 20 or a short upright support rigid with plate 16. This could accommodate a tool for lighter duty applications for close work around flowers and vegetables in a confined location such as a flowerbox or planter.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A cultivating tool comprising:
a generally horizontal plate;
a plurality of blades extending downwardly from said plate, for engagement with the ground,
each of said blades comprising a first section presenting a leading knife-like edge and a second section which presents a trailing edge with a flange section extending from said trailing edge at an acute angle; and
a handle adapted to be coupled with said plate.

2. The invention of claim 1, wherein said trailing edge presents a curved surface which terminates at the ground engaging end of said blade.

3. The invention of claim 2, wherein each of said flange sections comprises a first flange segment extending from said trailing edge at an acute angle in a first direction and a second flange segment extending from said trailing edge at an acute angle in the opposite direction.

4. The invention of claim 3, wherein each of said acute angles is between 30 and 60 degrees.

5. The invention of claim 4, wherein each of said blades includes a reinforcing rib at approximately the blade center.

6. The invention of claim 4, wherein there are at least four of said blades approximately equidistant from each other.

7. The invention of claim 6, wherein is included a mixing fork depending from said plate at approximately the center of an imaginary circle passing through said blades.

8. The invention of claim 7, wherein said mixing fork is generally wishbone shaped with its spaced apart legs secured to said plate.

9. The invention of claim 8, wherein said mixing fork presents a curvilinear surface.

10. The invention of claim 1, wherein said blades are disposed generally perpendicular to said plate.

11. The invention of claim 10, wherein said leading edge presents a curvilinear surface.

12. The invention of claim 11, wherein is included a stem section projecting upwardly from said plate and adapted to be coupled with said handle.

13. The invention of claim 12, wherein said handle and said stem are adapted to be adjustably coupled for varying the height of said tool.

14. The invention of claim 10, wherein said leading edge is tapered in a vertical plane.
